(19) United States
(12) Patent Application Publication
(10) Pub. No.: US 2007/0246486 A1
(43) Pub. Date: Oct. 25, 2007

(54) Conversion Kit to Retrofit Kitchen Sink Soap Dispenser to a Liquid Soap Bottle

(76) Inventor: Frank Calandrino, Ocean Port, NJ (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/670,454

(22) Filed: Feb. 2, 2007

Related U.S. Application Data
(60) Provisional application No. 60/765,288, filed on Feb. 3, 2006.

(51) Int. Cl. B65D 88/54; B67D 5/00; B67D 5/40; B67D 3/00

(52) U.S. Cl. 222/321.1; 222/382; 222/464.1; 222/478

(57) ABSTRACT

A sink based liquid soap dispenser comprising a container for holding liquid soap; an adapter for connection to a container of liquid soap, the adapter having a vent hole and a cap adapter extending outwardly from the cap; a hollow flow tube attached to the underside of the cap and extending into the container; a pump dispenser adapted to connect to the sink and having an intake adapter; and a flexible hollow tube connected to the adapter at one end and an intake adapter connected to a pump dispenser.

### CROSS REFERENCE TO RELATED APPLICATION

This application claims benefit to provisional application 60/765,288 filed on Feb. 3, 2006, entitled Conversion Kit to Retrofit Kitchen Sink Soap Dispenser to a Liquid Soap Bottle, which is incorporated by referenced herein in its entirety.

### FIELD OF THE INVENTION

The present invention is directed toward the field of soap dispensing systems for kitchen sinks and other applications. In particular, the present invention comprises a device that can fit over any type of soap supply bottle, thereby eliminating the need to use other replaceable containers or refill smaller containers.

### BACKGROUND OF THE INVENTION

Liquid soaps have grown in great popularity in recent years. Liquid soap is more hygienic than bar soap, which often contains grit and germs. Most liquid soap is dispensed from small throw away containers. These containers typically do not hold a significant quantity of soap and must be discarded. A number of patents have been issued in the area of soap dispensing systems.

U.S. Pat. No. 6,910,604 discloses a liquid soap dispensing apparatus having a counter-top mounting system that makes it possible to securely anchor the liquid dispensing device to a surface, such as a counter-top and still allow for easy removal for portability, so that the dispenser can be transported and used in other areas. The apparatus also allows the soap reservoir to be easily refilled and utilizes readily available pump components.

U.S. Pat. No. 4,470,523 discloses a liquid soap dispenser whose container is formed of flexible plastic material and is provided with a flat rear wall and an externally-threaded nipple projecting from the front wall adjacent the base. The nipple has a cap screwed thereon which incorporates a pivoted spigot, so that when folded in, it seals the nipple and when folded out, it creates an outlet from which liquid soap is discharged when the front wall is pressed. A pad is secured to the rear wall whose outer surface has a layer of pressure-sensitive adhesive thereon. A base sheet is also provided whose area is greater than that of the pad. The sheet has a pressure-sensitive adhesive coating on its underface that makes it possible to adhere and conform the sheet to a selected wall site after the container pad is pressed against the central zone of the sheet to securely anchor the dispenser on the wall.

U.S. Pat. No. 4,625,896 discloses a device for dispensing liquid soap, which is affixable to a unit such as a mixer tap or a tap outlet that delivers water to wash basins or sinks and comprises at least one delivery outlet for liquid soap. The outlet is affixed thereto or integrally forms therewith a substantially part annular collar which is insertable between the base of the body of the unit which delivers water and the plane on or against which the unit is fixed. The collar is secured in such a location by a threaded connection utilized for fixing the unit to the plane.

U.S. Pat. No. 5,114,048 discloses a faucet assembly having an integral dispenser for supplying liquid products (such as soap, lotion, and the like) adjacent to the flow of water therefrom. The faucet assembly includes a housing that has a conventional mixer tap mounted therein for supplying water from a spigot. A pair of upstanding liquid dispenser housings are formed integrally with or secured to the faucet assembly housing. Within each of these dispenser housings, a manually operable pump assembly is disposed. The pump assemblies are manually operable to pump liquid products from respective liquid reservoirs to a dispenser block located within the faucet assembly adjacent to the spigot thereof. The dispenser block discharges the liquid products adjacent to the flow of water from the faucet assembly. The dispenser block may be formed integrally with the faucet housing or as a separate piece releasably secured thereto.

U.S. Pat. No. 5,226,566 discloses a substantially modularized countertop mounted liquid soap dispensing system, including a delivery module that comprises a housing, a frame, a delivery spout and an actuator channel through this frame. An actuator rod assembly resides in the actuator channel. The lower portion of the actuator rod assembly is free. Attached to the lower portion of the frame is a canister top adapted to engage a canister for enclosing a disposable liquid soap reservoir module. The liquid soap reservoir module is substantially completely enclosed, such that the liquid soap within is not exposed to the atmosphere until it is pumped from the module. The disposable reservoir module includes an enclosing top section, a lower cap and a pump affixed to the lower cap. There is a guide cylinder extending from the enclosing top section to the pump for receipt of the free end of the piston rod assembly. A flexible tube extends from the pump and is easily inserted into and withdrawn from the delivery spout.

U.S. Pat. No. 5,857,594 discloses a device which is attached to the end of a standard kitchen faucet and dispenses liquid soap on to an object to be washed. When dispensing soap, the device cuts off the flow of water to permit the user an opportunity to wash the object and conserve water. The device is activated by rotating the device in a first direction, which cuts off the flow of water and dispensed liquid soap. When the device is returned to the original position, the water flow is restored and the dispensing of liquid soap is stopped.

U.S. Pat. No. 6,142,342 discloses a counter-mounted apparatus for dispensing viscous liquid, such as hand soap, and includes an improved reservoir assembly. The reservoir assembly includes a container housing in which a predetermined quantity of the viscous liquid is contained. Bayonet tabs or other suitable means may be provided on the housing to effect direct attachment to a canister top of the dispenser. At least one actuator opening is defined in a top portion of the container housing for receipt of the dispenser's actuator rod. A free distal end of the rod pushes against an engaging element located within the housing. When the engaging element is reciprocatively moved by the actuator rod, a pump device located in the housing functions to push the viscous liquid into a flexible delivery tube. The pump device is preferably a common lotion pump which has been suitably modified.

U.S. Pat. No. 6,390,340 discloses a liquid soap dispenser for dispensing liquid soap. The liquid soap dispenser includes a housing with a soap reservoir and a pressurized gas reservoir disposed in the housing. The pressurized gas reservoir is in fluid communication with the soap reservoir. A dispensing valve is provided between the pressurized gas reservoir and the soap reservoir for selectively opening and closing the passage of gas from the pressurized gas reservoir to the soap reservoir. The dispensing valve has an actuator extending from the housing. An elongate flexible dispensing tube in fluid communication with the soap reservoir outwardly extends from the housing.

U.S. Design Pat. No. D438,041 discloses an ornamental design for a dispenser spout.

U.S. Pat. No. 6,695,174 discloses a dispenser for a liquid or viscous soap. The dispenser includes a disposable soap container that has a discharge end and a feed pump for pumping a dose of soap out of the discharge end, a housing for receiving the soap container via a front aperture in the housing, and a cover for closing the front aperture of the housing. This cover is pivotally mounted about a horizontal swing axis extending across an upper edge in the front aperture of the housing. Furthermore, the cover is arranged to be able to swing between a first swing position in which the front aperture is clear, a second swing position in which the front aperture is covered and the cover is in contact with the pump, and at least a third swing position in which the cover has activated the feed pump. The dispenser has a simple, inexpensive design with no wearing parts that require maintenance.

U.S. Pat. No. 6,343,724 discloses a valve assembly for a fluid dispensing unit, particularly for a soap dispenser, that comprises a resilient valve member secured within a chamber. The valve member comprises a sealing member, a support member and a securment member. The support member carries a sealing member, at one end, and a securement member at the other end. The valve member, when secured within the chamber, is under compression with the sealing member biased by the support member engaging and sealing the inlet port of the chamber to the fluid flow, there through other than fluid flow under a pressure differential across the sealing member, sufficient to resiliently deflect the sealing engagement. The valve member is formed entirely from recyclable plastic as an integral unit by injection molding.

U.S. Pat. No. 6,776,310 discloses an improved structure of a soap dispenser head to deliver a fixed amount of soap liquid and to prevent any leakage of soap liquid, essentially comprising a graded trough on either side of a soap delivery head of a soap dispenser; a soap liquid inlet on either side of the graded trough; a soap liquid outlet at the bottom of the graded trough; a piston penetrating the graded trough, a cap on the top of the graded trough, a ring seat at the bottom of the piston ring of the piston; a coil inserted on to the bottom of the ring seat, a stop at the lower end of the piston; a retaining hole at the lower end of the piston, a hole on the stop for the retaining to penetrate through the stop and inserted into the retaining hole in the piston thus to position the stop in the lower end of the piston, so that when the soap dispenser is depressed for the piston in the soap delivery head to move downward, the ring seat on the piston closes up the soap liquid inlet on either side of the graded trough of the soap delivery head to avoid continuous feeding of the soap liquid to deliver only a fixed amount of soap liquid while the sop completely closes up the soap liquid outlet once the piston returns to its original piston to prevent leakage of soap liquid.

U.S. Patent Application No. 20050150909 discloses a soap supply bore intersecting the main through bore; a soap dispenser controlling dispensing of soap from a container; and a supply tube connecting the soap dispenser to the soap supply bore of the suction tube. The soap dispenser includes an inner tube that is fluidly connected with the supply tube and an outer tube movably mounted over the inner tube and connected with the container. The outer tube fluidly connects with the soap from the container and adapts to be fluidly connected with the inlet of the inner tube. A spring applies pressure between the inner tube and the outer tube in a direction to move them apart. A valve permits soap to enter the inlet of the inner tube only when the outer tube is moved toward the inner tube against the force of the biasing device.

U.S. Patent Application No. 20050155988 discloses a fluid dispenser system which includes a container that is mounted below a mounting surface. A base is mounted above the mounting surface. The base defines an opening configured to allow passage of the fluid when filling the container. A dispenser body is detachably coupled to the base to allow removal of the dispenser for filling the container with the fluid from above the mounting surface. The dispenser body has a moveable handle that is moveable for manually pumping the fluid and a fixed spout that is fixed in position relative to the mounting surface when the fluid is dispensed from the spout.

U.S. Patent Application No. 20030132248 discloses a liquid soap dispensing apparatus that has a counter-top mounting system, making it possible to securely anchor the liquid dispensing device to a surface and still allow easy removal for portability. The apparatus also allows the soap reservoir to be easily refilled and utilizes readily available pump components.

U.S. Patent Application No. 20030168471 discloses a washing system for dispensing a liquid cleanser or lotion that includes a housing that encloses a first and second reservoir and a tube system for connecting in fluid communication. The first and second reservoirs connect to a manual valve that is located on or outside of the housing. The first reservoir comprises a collapsible, airtight bag containing liquid cleanser or lotion and is located above the second reservoir. As a result, the soap or lotion will flow into the second reservoir from the first reservoir due to gravity when the first reservoir bag is installed. The second reservoir provides additional liquid storage for use between replacement of the first reservoir.

U.S. Patent Application No. 20020014256 discloses a self contained soap dispensing apparatus that has a hollow body with an inner chamber for retainment of liquid soap, an outer surface, and passages or ducts connecting the inner chamber to the outer surface which has bristles thereon. A pump within the inner chamber allows soap to flow from the inner chamber to the outer surface on demand. The soap dispensing apparatus is readily portable and can be used in a wide variety of locations, such as an automobile, an airplane, an RV, and the like.

U.S. Patent Application No. 20030071058 discloses an adapter that is mounted on an intermediate container that has a coded cylindrical jacket. The coded parts are positioned on the neck of a suitable supply container and can be fitted. To prevent the contamination of the intermediate container, the latter has a spring loaded internal sealing plug which ensures the hygienic sealing of said container, even prior to use and when the supply container is being changed. To prevent interruptions in the operation, a reliable fill-level indicator is provided. The device thus ensures improved hygienic dispensing of soap-solution in dispensers.

U.S. Patent Application No. 20030006246 discloses a device for the linear drive of a pumping member in a soap-type dispenser that includes a crank mechanism with a crank disc and a push rod transmitting a linear movement to a piston rod. Disengageable coupling members are located between the push rod and the piston rod to disengage the piston rod when an actuating signal is not present. The coupling members can be re-engaged upon further movement of the crank disc. The device may be employed in conjunction with a motor driven pumping member and a sensor with a control circuit to detect the presence of a hand to be supplied with the soap and generate the actuating signal.

U.S. Patent Application No. 20020008117 discloses a system of dispensing viscous liquid, including a mounting plate, a reservoir and a dispensing mechanism for use with a bottle containing liquid and having a viscosity up to about 20,000 cps. The mounting plate has a generally flat rectangular surface with a first and second pair of vertically extending mounting tracks that extend outwardly from the plate. A first shelf is positioned generally horizontally and extends from the plate below and between the first pair of tracks. A second shelf is positioned generally horizontally and extends outwardly of the plate, generally below and between the second pair of tracks. A flexible first latch is positioned between the first shelf and the second pair of tracks. The mechanism below the second shelf supports the mechanism for dispensing liquid. A bottle has a neck with a membrane capable of being punctured and a dove tail member extending longitudinally of the bottle, spaced to slide between at least one of the first and second pairs of mounting tracks. The reservoir has a housing with an end for receiving the bottle of liquid and an opening at the other end through which liquid flows. The housing has a punch that extends upwardly and is positioned to extend into the bottle neck and to puncture the membrane. The reservoir and variations of the plate are disclosed, as are the bottle variations and different pumping mechanisms.

U.S. Patent Application No. 20030141318 discloses a dispenser serving a dose of liquid or viscous soap. The main components of the dispenser consist of a disposable soap container that has a discharge end mainly at the bottom in the state of use and a feed pump for pumping a dose of soap out of the discharge end; a housing for receiving the soap container via a front aperture in the housing; and a cover for closing the front aperture of the housing. This cover is pivotally mounted about a horizontal swing axis extending across an upper edge in the front aperture of the housing. Furthermore, the cover is arranged to be able to swing between a first swing position in which the front aperture is clear, a second swing position in which the front aperture is covered and the cover is in contact with the pump, and at least a third swing position in which the cover has activated the feed pump by means of a manual action. The dispenser has a simple, inexpensive design with no wearing parts that require maintenance. By merely replacing the disposable soap container, the soap supply of the dispenser can be restored quickly and easily without subsequently having to clean the dispenser. Furthermore, the dispenser is easy and comfortable to operate, even to persons having weak hands and fingers and/or impaired sight.

U.S. Patent Application No. 20050121458 discloses an invention which provides an apparatus for dispensing liquids held by a container located at a position distal to the dispenser. The disclosed invention includes a dispenser, a container, a universal cap, and a conduit assembly with a coupling device. The coupling device provides the invention with the ability to attach the conduit to typical dispenser inlets. The universal cap provides the invention with the ability for a wide variety of containers to be connected to the dispenser.

U.S. Patent Application No. 20030127470 discloses a liquid dispensing apparatus that has improved sanitary, aesthetics and stabilizing aspects. The liquid dispensing apparatus comprises a dispensing housing designed to contain a soap filled bottle. Depending on particular configurations, the housing may be designed as an open or a closed system. The housing has a sleek, streamlined design with a dispensing button, which tends to have a rounded appearance that accents the shape of the remainder of housing. In accordance with various other aspects within the housing is a stabilization system which prevents bottles which are not designed to engage housing from being inserted into housing. In addition, or alternatively, the housing may have a support structure which allows the soap bottle to rest within housing with a lower propensity to wobble.

U.S. Patent Application No. 20010030203 discloses a container for dispensing a fluid containing a main body portion that has an internal cavity, a pump dispensing mechanism mounted to dispense a fluid from the internal cavity, the bottom wall of the main body being concave to define a centrally located sump with a distal end of a dipstick to be located proximate the sump, and a support base being designed to engage and interlock with the main body side wall. The main body may be formed as an extrusion blow molded bottle.

While a number of soap dispensers have been patented, there has not been a soap dispenser that comprises a kit that can be easily attached to a sink or similar water dispensing system.

It is an object of the present invention to provide a novel liquid soap dispensing system.

It is a further object of the present invention that the novel liquid soap dispensing system is able to be adapted to be retrofit with a sink.

It is yet a further object of the present invention that the liquid soap dispensing system is able to be used with a large container of liquid soap.

### SUMMARY OF THE INVENTION

In accordance, the present invention is a conversion kit for a liquid soap sink dispenser that comprises a cap adapter for connection to a container of liquid soap. The cap adapter has a vent hole and a hollow adapter extending outwardly. The pump dispenser adapts and connects to the sink and has an intake adapter. A flexible hollow tube is connected to the cap adapter at one end and the intake adapter is connected to the intake adaptor of the pump dispenser at a second end.

In a further embodiment, the present invention is a conversion kit for a sink dispenser that comprises a cap adapter for connection to a container of liquid soap. The cap adapter has a vent hole and a hollow adapter that creates a hole through the cap. A pump dispenser is adapted to connect to a sink and has an intake adapter. A flexible tube is connected to the adapter at one end and an intake adapter is connected to a pump dispenser with a means of connecting the pump dispenser to a sink.

In still a further embodiment, the present invention is a sink based liquid soap dispenser that comprises a container for holding liquid soap; an adapter for connection to a container of liquid soap, the adapter having a vent hole and a cap adapter extending outwardly from the cap; a hollow flow tube attached to the underside of the cap and extending into the container; a pump dispenser adapted to connect to the sink and having an intake adapter; and a flexible hollow tube connected to the adapter at one end and an intake adapter connected to a pump dispenser.

### BRIEF DESCRIPTION OF THE DRAWINGS

FIG. 1 is a side perspective view of the present invention.

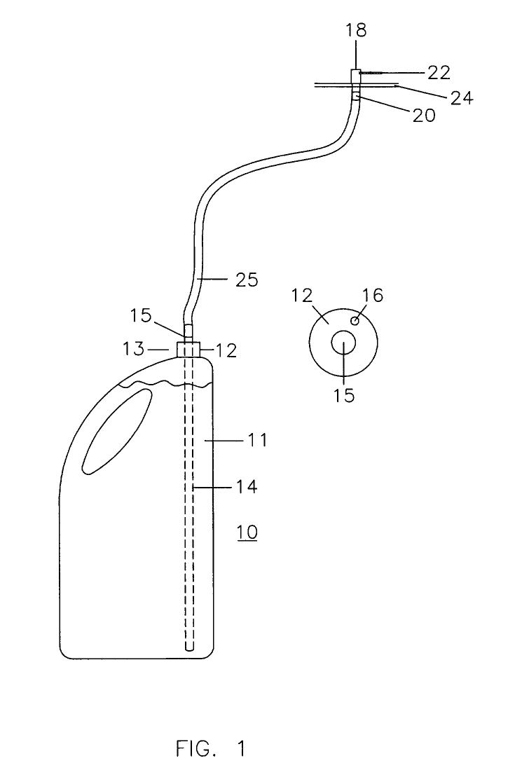

### DESCRIPTION OF THE INVENTION

The present invention is described with reference to the enclosed Figures, wherein the same numbers are used where applicable.

The invention comprises a container 10 for holding a liquid soap 11 which is typically supplied from a plastic container 10. This container 10 may comprise an original liquid carton and is preferably constructed from a plastic or polymer material.

The top opening of the container 13 will have a cap 12 which should be vented. The cap 12 will comprise a small cylindrical through hole 16. The top of the cap 12 also includes a hollow cylindrical adapter 15 attached to the cap 12. The adapter 15 is similarly hollow and forms a through hole 16 on the cap 12.

The container will have a rigid hollow tube member 14 which will be fully inserted into the container 10 and which acts as a conduit for the soap 11. The hollow tube 14 attaches to the underside of the cap 12 proximate cap adaptor 15. The system also includes a pump mechanism 18. The mechanism 18 includes an adapter 22 to attach to the top of a sink 24. The pump 18 has an intake adapter 20 at its lower intake position.

Externally flexible tubing 25 attaches to the top of the cap adapter 15 and extends to an intake adapter 20 affixed to the soap pump 18. The soap pump mechanism 18 attaches to the operative sink basin support 24. The system can thus be used to pump significant portions of liquid soap 11.

The reservoir conversion kit is for household kitchen use, but may be used in any liquid soap dispenser to eliminate having to constantly refill a smaller attached soap reservoir.

With the present invention, liquid soap will no longer need to be poured from the original large container it was purchased in into a smaller soap dispenser reservoir every time the reservoir runs empty. Now soap can be drawn directly from the container it was purchased into the place where it is commonly stored, under the sink.

The present invention has been described with reference to the above-discussed preferred embodiment. The true nature and scope of the invention is to be determined with reference to the claims appended hereto.

I claim:

1. A conversion kit for a liquid soap sink dispenser comprising:
a cap adapter for connection to a container of liquid soap, the cap adapter having a vent hole and a hollow adapter extending outwardly;
a pump dispenser adapted and connected to the sink and having an intake adapter; and
a flexible hollow tube connected to the cap adapter at one end and the intake adapter connected to the intake adaptor of the pump dispenser at a second end.

2. A conversion kit for a sink dispenser comprising:
a cap adapter for connection to a container of liquid soap, the cap adapter having a vent hole and a hollow adapter creating a hole through the cap;
a pump dispenser adapted to connect to a sink and having an intake adapter;
a flexible tube connected to the adapter at one end and an intake adapter connected to a pump dispenser; and
means of connecting the pump dispenser to a sink.

3. A sink based liquid soap dispenser comprising:
a container for holding liquid soap;
an adapter for connection to a container of liquid soap, the adapter having a vent hole and a cap adapter extending outwardly from the cap;
a hollow flow tube attached to the underside of the cap and extending into the container
a pump dispenser adapted to connect to the sink and having an intake adapter; and
a flexible hollow tube connected to the adapter at one end and an intake adapter connected to a pump dispenser.
